(19) United States
(12) Patent Application Publication
(10) Pub. No.: US 2020/0057349 A1
(43) Pub. Date: Feb. 20, 2020

(54) DISPLAY UPDATE METHOD FOR NONVOLATILE DISPLAY DEVICE, DISPLAY UPDATE DEVICE FOR NONVOLATILE DISPLAY DEVICE, AND DISPLAY SYSTEM

(71) Applicant: SHISEIDO COMPANY, LTD., Tokyo (JP)

(72) Inventors: Yasuo KATO, Tokyo (JP); Kazuhisa OHNO, Tokyo (JP); Ryuta OKAZAKI, Tokyo (JP); Tomoyuki KAWASOE, Tokyo (JP)

(73) Assignee: SHISEIDO COMPANY, LTD., Tokyo (JP)

(21) Appl. No.: 16/610,541

(22) PCT Filed: Apr. 27, 2018
(86) PCT No.: PCT/JP2018/017215

§ 371 Date: Nov. 4, 2019

(30) Foreign Application Priority Data
May 10, 2017 (JP) 2017-094226

(51) Int. Cl. G02F 1/1685; A45D 29/00; A45D 31/00

(52) U.S. Cl. CPC G02F 1/1685; A45D 31/00; A45D 29/004

(57) ABSTRACT

A fake nail including an electronic paper as a display member and having a simple structure, which can easily update a display, is provided. A fake nail 1 including the electronic paper as the display member is mounted on a nail of a user using a fixing member 2 such as an electrically-conductive binding material and the like. In a state wherein the fake nail 1 is mounted, a display update device 3 generates an ion wind, and the generated ion wind is blown onto the fake nail 1. By electrical charging caused by the ion wind, an electric potential is applied to the electronic paper contained in the fake nail 1, and the display of the electronic paper is updated to a color according to the electric potential.

### FIELD OF TECHNOLOGY

The present invention relates to a technology for updating a display of a nonvolatile display device such as an electronic paper and the like.

### BACKGROUND ART

As the technology for updating the display of the nonvolatile display device, such as electronic paper and the like, there is known a technology to incorporate a display control device for controlling the display of the electronic paper, and a battery into a fake nail provided with the electronic paper used as a display member, so as to update the display of the electronic paper by the display control device while using electrical power of the battery (for example, Patent Document 1).

Also, there is known a technology to incorporate the display control device and a power receiving device of a non-contact power transfer into the fake nail provided with the electronic paper used as the display member, so as to update the display of the electronic paper by the display control device while using electrical power which has been fed from an outside in a non-contact manner at a charging device (for example, Patent Document 2).

Also, as a technology related to the present application, there is known an ion generating device for generating an ion wind having positive ions and an ion wind having negative ions as well (for example, Patent Documents 3 and 4).

### PRIOR ART DOCUMENTS

### Patent Documents

Patent Document 1: Japanese Patent Application Publication No. 2016-168294

Patent Document 2: Japanese Patent Application Publication No. 2012-20035

Patent Document 3: Japanese Patent Application Publication No. 2007-135934

Patent Document 4: Japanese Patent Application Publication No. 2006-207553

### SUMMARY OF THE INVENTION

### Problems to be Solved by the Invention

According to the aforementioned technologies for updating the display of the electronic paper of the fake nail, at least, it is necessary to provide a device for generating the electrical power such as the battery, the power receiving device of the non-contact power transfer, or the like, and the display control device for controlling the display of the electronic paper in the fake nail by attaching to the electronic paper, so that a structure of the fake nail becomes complicated so as to prevent the fake nail from a low cost or a weight reduction.

Furthermore, such problems occur likewise even in various articles using other nonvolatile display devices as the display member.

Therefore, in the present invention, an object of the present invention is to simplify a structure of an article using the nonvolatile display device as the display member while allowing the display of the nonvolatile display device to easily update.

### Means for Solving the Problems

In order to obtain the aforementioned object, in the present invention, as a display update method for a nonvolatile display device for updating a display of the nonvolatile display device which carries out a change of the display according to an electric potential difference between a display surface and a surface on a side opposite to the display surface, there is provided a display update method for a nonvolatile display device including a first step generating an ion wind, and a second step blowing the ion wind generated by the display update device toward a first surface of the nonvolatile display device where one of the display surface and a surface on the side opposite to the display surface of the nonvolatile display device is the first surface using a display update device having a function for generating the ion wind.

Here, such display update method for the nonvolatile display device may be formed such that in the second step, in a state wherein the first surface of the nonvolatile display device is partially masked using a predetermined antistatic member so as not to be charged by the ion wind, the ion wind is blown toward the first surface of the nonvolatile display device.

Here, in the aforementioned display update method for the nonvolatile display device, the nonvolatile display device may be an electronic paper as well.

Also, in the aforementioned display update method for the nonvolatile display device, the nonvolatile display device may be the electronic paper provided in a fake nail as a display member, and the first surface is the display surface of the electronic paper. In the second step, the ion wind generated by the display update device may be blown toward the display surface of the electronic paper from an outside of the fake nail onto the fake nail fixed such that the display surface of the electronic paper becomes the outside on a nail of a human body.

Also, in the present invention, in order to obtain the aforementioned object, in the display update device for updating the display of the nonvolatile display device, which carries out the change of the display according to the electric potential difference between the display surface and the surface on the side opposite to the display surface, there are provided an ion-wind generating portion which can selectively generate a positive ion and a negative ion; and a blowing portion blowing the ion wind of the ion generated by the ion-wind generating portion toward the first surface of the nonvolatile display device where one of the display surface and the surface on the side opposite to the display surface of the nonvolatile display device is the first surface.

Also, in the present invention, there is provided a display system comprising the aforementioned display update device, and the nonvolatile display device together as well.

Also, in the present invention, there is provided the display system comprising the aforementioned display update device, and an antistatic member which partially masks the first surface of the nonvolatile display device so as not to be charged by the ion wind together as well.

Here, in the aforementioned display update device or display system, the nonvolatile display device may be the electronic paper as well. Also, in that case, the electronic paper may be provided in the fake nail as the display member.

According to the aforementioned invention, relative to an individual nonvolatile display, without securely providing a device for generating electrical power such as a battery, a power receiving device of a non-contact power transfer, or the like, and a device for controlling the display of the nonvolatile display device, the update of the display can be carried out.

Also, only by a simple operation of blowing the ion wind from the display update device, the display of the nonvolatile display can be updated.

Therefore, the update of the display of the nonvolatile display device can be simplified, and a structure of an article using the nonvolatile display device as the display member can be simplified.

### Effect of the Invention

As mentioned above, according to the present invention, while the display of the nonvolatile display device can be easily updated, the structure of the article using the nonvolatile display device as the display member can be simplified.

### BRIEF DESCRIPTION OF THE DRAWINGS

FIG. 1(a1) to FIG. 1(b2) are drawings showing a structure of a fake nail according to an embodiment of the present invention.

FIG. 2(a) and FIG. 2(b) are drawings showing a condition wherein the fake nail is mounted according to the embodiment of the present invention.

FIG. 3(a) and FIG. 3(b) are drawings showing a structure of a display update device according to the embodiment of the present invention.

FIG. 4(a) to FIG. 4(c) are drawings showing procedures of a display update according to the embodiment of the present invention.

FIG. 5(a) to FIG. 5(c) are drawings showing another example of the structure of the fake nail according to the embodiment of the present invention.

FIG. 6(a) to FIG. 6(d) are drawings showing another example of the procedures of the display update according to the embodiment of the present invention.

### BEST MODES OF CARRYING OUT THE INVENTION

Hereinafter, embodiments of the present invention will be explained as examples applied to a fake nail using an electronic paper as a display member.

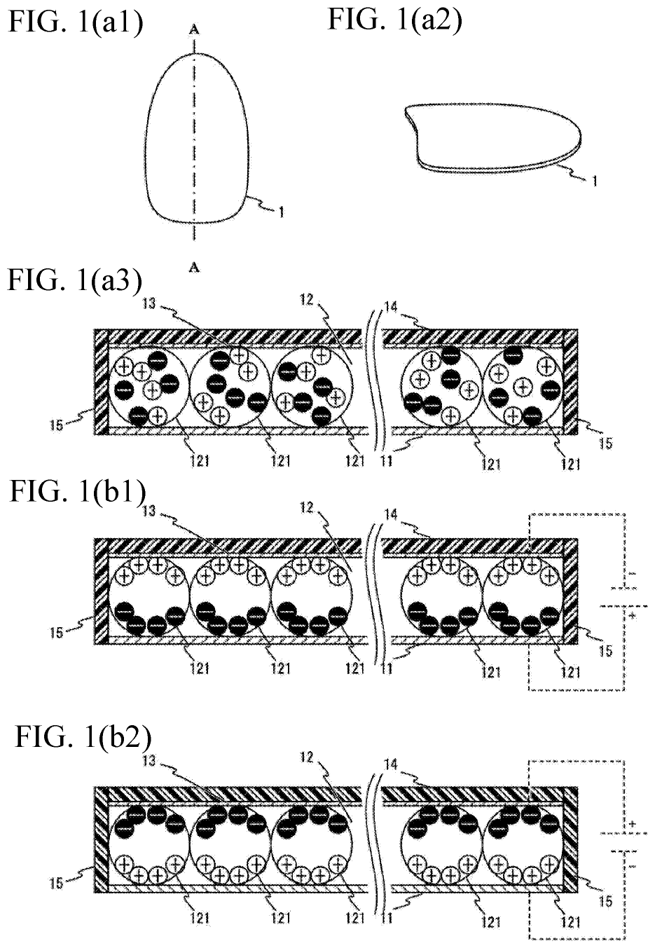

FIG. 1(a1) to FIG. 1(b2) show a structure of the fake nail according to the present embodiment.

FIG. 1(a1) shows an upper face of a fake nail 1; FIG. 1(a2) shows a perspective view of the fake nail 1; and FIG. 1(a3) shows a cross-sectional end portion taken along cross-sectional line A-A in FIG. 1(a1).

As shown in the drawings, the fake nail 1 has a curved shape similar to a human nail as a whole, and a concave side is used as a lower face to be fixed onto the nail, and a convex side is used as the upper face to exhibit an appearance relative to an outside.

Then, the fake nail 1 has a structure such that a lower-side sheet 11 which is a transparent electrically-conductive sheet processed in a shape similar to the nail; a display layer 12 (an ink layer 12); a transparent electrode layer 13; and an upper-side sheet 14 which is a transparent insulating sheet processed in the shape similar to the nail, are laminated toward an upper face side from a lower face side in the order of the lower-side sheet 11, the display layer 12, the transparent electrode layer 13, and the upper-side sheet 14.

Here, the transparent electrode layer 13 is an electrically-conductive layer such as ITO or the like formed over an entire surface on a surface of a lower side of the upper-side sheet 14.

Also, in the fake nail 1, there is provided a rim 15 provided in such a way so as to cover between a peripheral surface of the lower-side sheet 11 and a peripheral surface of the upper-side sheet 14. Here, the rim 15 is formed using an insulator, and while protecting a peripheral surface of the fake nail 1, the rim 15 insulates between the lower-side sheet 11 and the transparent electrode layer 13.

Next, the display layer 12 is a layer of transparent microcapsules 121 wherein positively charged first particles and negatively charged second particles are housed together with a fluid, and the display layer 12 is formed by coating the microcapsules 121 above the lower-side sheet 11 or below the transparent electrode layer 13. Also, the first particles and the second particles are colored with different colors.

Then, the electronic paper is formed by such display layer 12, the electrically-conductive lower-side sheet 11, and the electrically-conductive transparent electrode layer 13. Then, a display on the display layer 12 on a face on the upper face side of the fake nail 1, which appears on the upper face of the fake nail 1, becomes the display of the electronic paper.

Meanwhile, in such electronic paper, the display is updated according to an electric potential difference between the lower-side sheet 11 and the transparent electrode layer 13 of the upper-side sheet 14.

Namely, as shown in FIG. 1(b1) and FIG. 1(b2), the first particles and the second particles inside each microcapsule 121 of the display layer 12 move according to the electric potential difference between the lower-side sheet 11 and the transparent electrode layer 13 of the upper-side sheet 14, and the electronic paper displays a color according to the electric potential difference.

For example, as shown in FIG. 1(b1), when an electric potential which becomes negative relative to the lower-side sheet 11 is applied to the transparent electrode layer 13 of the upper-side sheet 14, the positively charged first particles move to an upper-side-sheet 14 side, and the negatively charged second particles move to a lower-side-sheet 11 side, so that the display of the electronic paper becomes the color of the first particles. Also, as shown in FIG. 1(b2), when the electric potential which becomes positive relative to the lower-side sheet 11 is applied to the transparent electrode layer 13 of the upper-side sheet 14, the negatively charged second particles move to the upper-side-sheet 14 side, and the positively charged second particles move to the lower-side-sheet 11 side, so that the display of the electronic paper becomes the color of the second particles.

Next, the display of the electronic paper which is carried out by the first particles and the second particles in the aforementioned manner is not lost even when the electric potential difference between the lower-side sheet 11 and the transparent electrode layer 13 of the upper-side sheet 14 is eliminated since the first particles and the second particles maintain positions thereof. Therefore, the display of the electronic paper is maintained as it is even when electrical power is not supplied to the electronic paper.

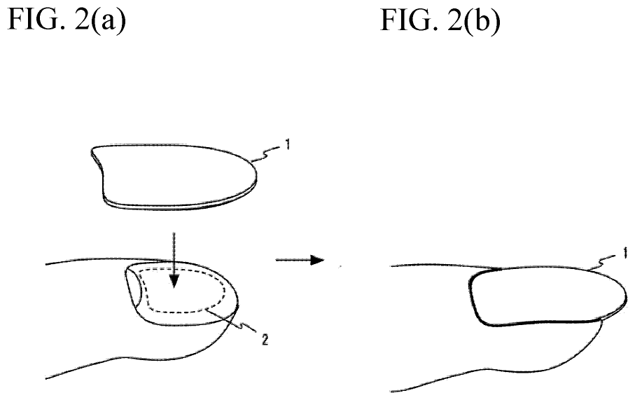

Next, as shown in FIG. 2(a) and FIG. 2(b), such fake nail 1 is used by fixing the lower face of the fake nail 1 on a nail of a user using a fixing member 2 which is an electrically-conductive binding material, an electrically-conductive adhesive double-sided tape, or an electrically-conductive adhesive material.

Next, in the present embodiment, a display update device used for an update of the display of the electronic paper of the aforementioned fake nail 1 will be explained.

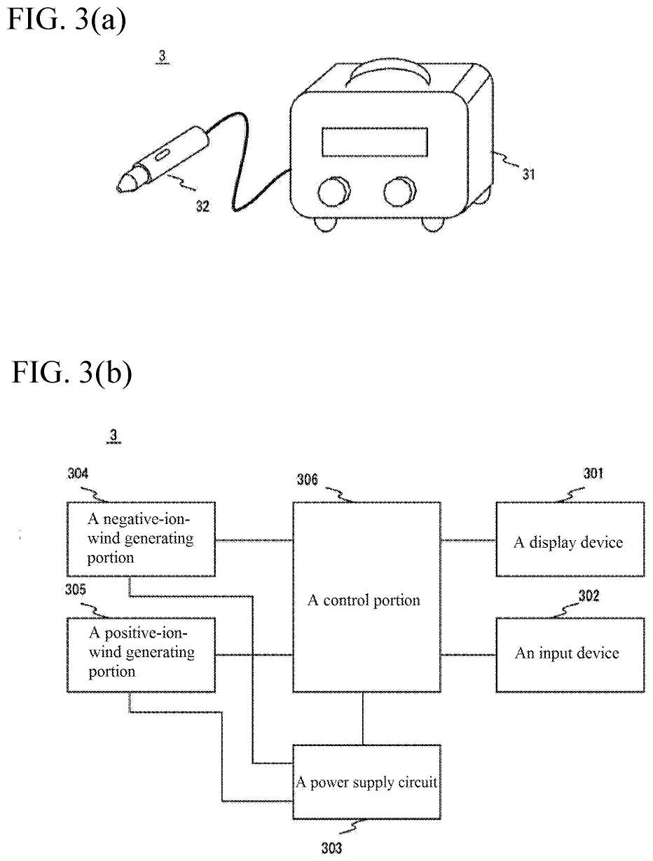

FIG. 3(a) shows an appearance of a display update device 3, and FIG. 3(b) shows a structure of the display update device 3.

As shown in FIG. 3(a), the display update device 3 is formed by a main member portion 31 and a hand unit 32.

Also, as shown in FIG. 3(b), the display update device 3 comprises a display device 301; an input device 302; a power supply circuit 303; a negative-ion-wind generating portion 304; a positive-ion-wind generating portion 305; and a control portion 306 for controlling the aforementioned respective portions.

Then, the power supply circuit 303 is housed in the main member portion 31, and generates a high-voltage power supply.

The negative-ion-wind generating portion 304 is housed in the hand unit 32, generates an ion wind having negative ions by a corona discharge using the high-voltage power supply and the like, and blows the ion wind from a nozzle of a tip of the hand unit 32. Also, the positive-ion-wind generating portion 305 is housed in the hand unit 32, generates an ion wind having positive ions by the corona discharge using the high-voltage power supply and the like, and blows the ion wind from the nozzle of the tip of the hand unit 32.

Next, the display update device 3 is provided, in the input device 302, a switch provided in the hand unit 32 for switching presence or absence of blowing of the ion wind from the hand unit 32; a switch provided in the main member portion 31 for switching the ion wind blowing from the hand unit 32 between the ion wind having the negative ions and the ion wind having the positive ions; a switch provided in the main member portion 31 for adjusting a amount of an output of the ion wind blowing from the hand unit 32, and the like.

Then, the control portion 306 controls the power supply circuit 303, the negative-ion-wind generating portion 304, and the positive-ion-wind generating portion 305 according to an operation of the respective switches comprised as the input device 302, and controls the presence or absence of blowing of the ion wind having the negative ions or the ion wind having the positive ions from the hand unit 32, or the amount of the output of the blowing ion wind.

Also, the control portion 306 carries out processing for displaying the presence or absence of blowing of the current ion wind; current ion wind as to which ion wind having the negative ions or the positive ions is blowing; the amount of the output of the ion wind, and the like in the display device 301.

Hereinafter, procedures of the update of the display of the electronic paper of the fake nail 1 which is carried out using such display update device 3 will be explained.

Now, as shown in FIG. 2(b), in a state wherein the fake nail 1 is fixed on a nail of a user, the lower-side sheet 11 of the fake nail 1 is in contact with the nail through the electrically-conductive fixing member 2, so that the electric potential of the electrically-conductive lower-side sheet 11 becomes the electric potential equal to the electric potential of a body of the user.

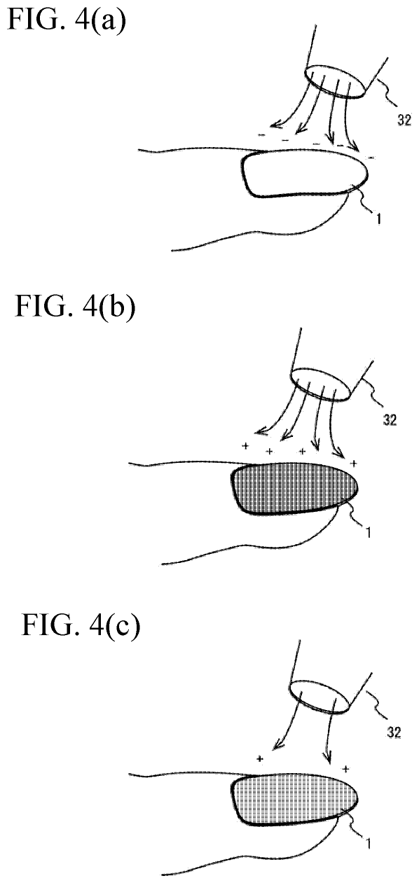

Then, in that state, in a case wherein the display of the electronic paper of the fake nail 1 is attempted to be updated to the display of the color of the first particles of the microcapsules 121 of the display layer 12, as shown in FIG. 4(a), the ion wind having the negative ions is generated in the display update device 3, and by operating the hand unit 32 of the display update device 3, the generated ion wind having the negative ions is applied on the fake nail 1.

Then, the negative ions contact the upper-side sheet 14 of the fake nail 1, and the transparent electrode layer 13 is charged through the upper-side sheet 14, so that the electric potential which becomes negative relative to the electric potential of the lower-side sheet 11 conducting to a human body is applied on a face on a transparent-electrode-layer 13 side of the display layer 12.

Then, accordingly, the positively-charged first particles move to the upper-side sheet 14 side, and the negatively-charged second particles move to the lower-side-sheet 11 side, so that the display of the electronic paper comes to have the color of the first particles so as to display the color of the first particles on the upper face of the fake nail 1.

Also, conversely, in a case wherein the display of the electronic paper of the fake nail 1 is attempted to be updated to the display of the color of the second particles of the microcapsules 121 of the display layer 12, as shown in FIG. 4(b), the ion wind having the positive ions is generated in the display update device 3, and by operating the hand unit 32 of the display update device 3, the generated ion wind having the positive ions is applied on the fake nail 1.

Then, the positive ions contact the upper-side sheet 14 of the fake nail 1, and the transparent electrode layer 13 is charged through the upper-side sheet 14, so that the electric potential which becomes positive relative to the electric potential of the lower-side sheet 11 conducting to a human body is applied on the face on the transparent-electrode-layer 13 side of the display layer 12.

Then, accordingly, the negatively charged second particles move to the upper-side sheet 14 side, and the positively charged first particles move to the lower-side-sheet 11 side, so that the display of the electronic paper comes to have the color of the second particles so as to display the color of the second particles on the upper face of the fake nail 1.

Also, next, in the aforementioned procedures of the update of the display of the electronic paper shown in FIG. 4(a) and FIG. 4(b), when a wind quantity or an electric charge amount of the ion wind applied to the fake nail 1 is reduced, as shown in FIG. 4(c), the display of the electronic paper of the fake nail 1 comes to have an intermediate color between the color of the first particles and the color of the second particles, so that the intermediate color appears on the upper face of the fake nail 1.

The embodiment of the present invention has been explained hereinabove.

Thus, according to the present embodiment, there is no need for incorporating a device for generating electrical power to the fake nail 1 such as a battery, a power receiving device of a non-contact power transfer, or the like, and the display control device for controlling the display of the electronic paper as well, the structure of the fake nail 1 can be simplified.

Also, while mounting the fake nail 1 on the nail, only by a simple operation of blowing the ion wind to the fake nail 1 from the display update device 3, the display of the electronic paper of the fake nail 1 can be updated.

Therefore, it is possible to easily enjoy the fake nail 1 based on the time, place, and occasion, for example, by making the color of the first particles of the microcapsules 121 as an elegant pink, and the color of the second particles as a vivid red so as to select the pink as the color of the fake nail 1 on the days at work and school, and the red as the color of the fake nail 1 on the holidays.

Now, here, in the aforementioned embodiment, the fake nail 1 is formed by laminating the electrically-conductive transparent lower-side sheet 11, the display layer 12, the electrically-conductive transparent electrode layer 13, and the insulating transparent upper-side sheet 14.

However, provided that the structure can include the electronic paper which can update the display by applying the ion wind on the upper face, the structure of the fake nail 1 may have another structure.

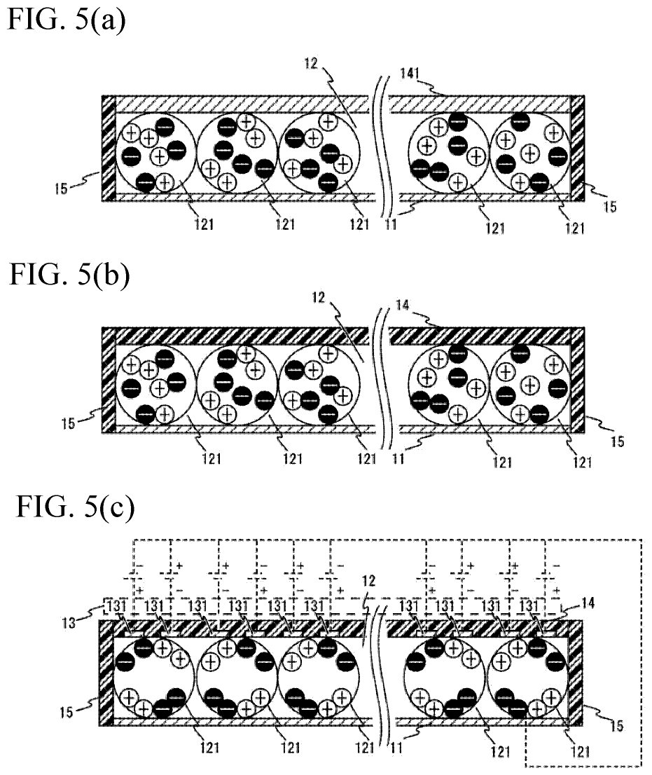

Namely, for example, as shown in FIG. 5(a), the fake nail 1 may be formed by laminating the electrically-conductive transparent lower-side sheet 11, the display layer 12, and an electrically-conductive transparent upper-side sheet 141.

Furthermore, as shown in FIG. 5(b), without providing an electrode on the display layer 12, the fake nail 1 may be formed by laminating the electrically-conductive transparent lower-side sheet 11, the display layer 12, and the insulating transparent upper-side sheet 14.

Furthermore, as shown in FIG. 5(c), while forming the fake nail 1 by laminating the electrically-conductive transparent lower-side sheet 11, the display layer 12, the electrically-conductive transparent electrode layer 13, and the insulating transparent upper-side sheet 14, there may be provided a plurality of transparent electrodes 131 which is separated from the transparent electrode layer 13 and is not conducted with each other.

Here, the plurality of transparent electrodes 131 may be provided in a matrix (square) state, or may be provided such that each transparent electrode 131 becomes the transparent electrode 131 having a segment shape respectively having a predetermined size and shape. Also, each transparent electrode 131 may be provided in such a way so as to be exposed on the upper face of the insulating upper-side sheet 14.

In that case, as shown in FIG. 5(c), the first particles and the second particles of the microcapsules 121 of the display layer 12 move according to the electric potential difference between the vicinity of the transparent electrode 131 and the lower-side sheet 11, so that by controlling the electric potential provided to the respective transparent electrodes 131, a pattern of a design, a letter, or the like can be displayed by the electronic paper.

Next, in the aforementioned embodiment, a case wherein the whole display of the electronic paper is updated to the same color has been shown, however, the update of the display of the electronic paper may be carried out such that the electronic paper displays the pattern of the design, the letter, or the like.

Namely, in that case, as the structure of the fake nail 1, there is used a structure without providing an electric conductor (the transparent electrode layer 13 in FIG. 1(a3) to FIG. 1(b2) or the electrically-conductive upper-side sheet 141 in FIG. 5(a)) which becomes an electrode in common with the whole upper face of the display layer 12 shown in FIG. 5(b) or FIG. 5(c).

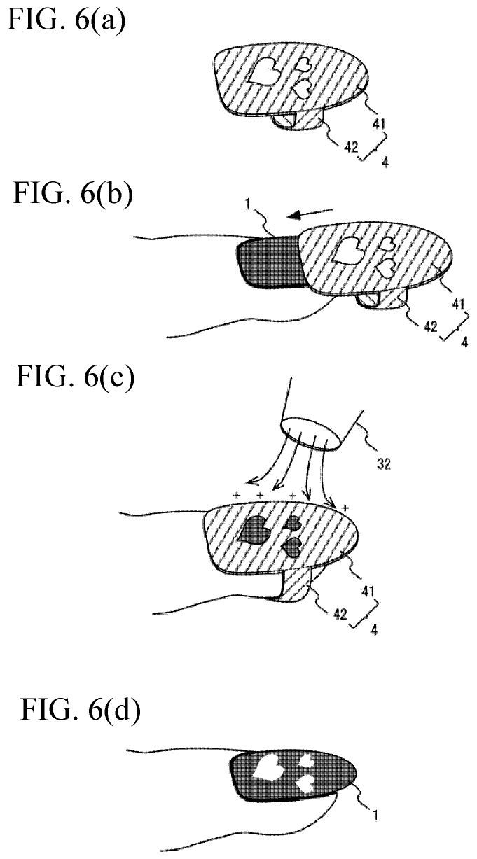

Also, in that case, a mask 4 as shown in FIG. 6(a) is used. Here, the mask 4 has a conductive property, and is formed by a shield portion 41 wherein a pattern is cut out, and a belt portion 42 for mounting the mask 4 on a finger.

Then, when the display of the electronic paper is updated, as shown in FIG. 6(b), the mask 4 is mounted on the finger by winding the belt portion 42 around the finger wherein the fake nail 1 is fixed such that the shield portion 41 covers the upper face of the fake nail 1.

Then, as shown in FIG. 6(c), the ion wind is blown onto the fake nail 1 from an upper portion of the mask 4 by operating the hand unit 32 of the display update device 3.

Then, since the mask 4 having the conductive property is in contact with the finger, only a portion of the insulating upper-side sheet 14 of the fake nail 1, which is located below the hollowed-out pattern of the shield portion 41 of the mask 4, is charged by the ion wind. Then, by the electrification, in the portion located below the hollowed-out pattern of the shield portion 41 of the display layer 12 (through the transparent electrodes 131 in a case using the structure in FIG. 5(c)), there is generated an electric potential difference between a face on an upper side of the display layer 12 and a face on the lower-side-sheet 11 side of the display layer 12, which is conducting to a human body, so that the display on the face on the transparent-electrode-layer 13 side of the display layer 12 is updated to the display of the color according to the generated electric potential difference.

Then, as a result, as shown in FIG. 6(d), the display of the electronic paper is updated to the display showing the pattern, so that the pattern appears on the upper face of the fake nail 1.

Here, an application to the fake nail 1 using the electronic paper as the display member has been explained as the example hereinabove, however, a technology for updating the display of the electronic paper shown in the present embodiment can be likewise applied to the update of the display of the electronic paper in an arbitrary article using the electronic paper as the display member.

Namely, the technology for updating the display of the electronic paper shown in the present embodiment can be likewise applied to clothes, accessories such as earrings, a pendant, and the like, a wallpaper, a clock face, a belt, advertisement goods, and the like using the electronic paper as the display member.

Also, the aforementioned embodiments can be likewise applied to a case of using a nonvolatile display device other than the electronic paper as the display member, the nonvolatile display device carrying out a change of the display according to the electric potential difference between a display surface and a surface on a side opposite to the display surface.

Also, in that case, in a case wherein the ion wind can be blown to the surface on the side opposite to the display surface of the nonvolatile display device, the display of the nonvolatile display device may be updated by blowing the ion wind to the surface on the side opposite to the display surface instead of the display surface of the nonvolatile display device.

### EXPLANATION OF SYMBOLS

1 . . . a nail, 2 . . . a fixing member, 3 . . . a display update device, 4 . . . a mask, 11 . . . a lower-side sheet, 12 . . . a display layer, 13 . . . a transparent electrode layer, 14 . . . an upper-side sheet, 15 . . . a rim, 31 . . . a main member portion, 32 . . . a hand unit, 41 . . . a shield portion, 42 . . . a belt portion, 121 . . . microcapsules, 131 . . . transparent electrodes, 301 . . . a display device, 302 . . . an input device, 303 . . . a power supply circuit, 304 . . . a negative-ion-wind generating portion, 305 . . . a positive-ion-wind generating portion, and 306 . . . a control portion

1. A display update method for a nonvolatile display device for updating a display of the nonvolatile display device, which carries out a change of the display according to an electric potential difference between a display surface and a surface on a side opposite to the display surface, comprising:
a first step of generating an ion wind using a display update device having a function for generating the ion wind; and
a second step of blowing the ion wind generated by the display update device toward a first surface of the nonvolatile display device where one of a display surface of the nonvolatile display device and a surface on a side opposite to the relevant display surface is the first surface.

2. The display update method for a nonvolatile display device according to claim 1, wherein in the second step, in a state wherein the first surface of the nonvolatile display device is partially masked using a predetermined antistatic member so as not to be charged by the ion wind, the ion wind is blown toward the first surface of the nonvolatile display device.

3. The display update method for a nonvolatile display device according to claim 1, wherein the nonvolatile display device is an electronic paper.

4. The display update method for a nonvolatile display device according to claim 1, wherein the nonvolatile display device is an electronic paper provided on a fake nail as a display member,
the first surface is a display surface of the electronic paper, and
the second step is a step wherein the ion wind generated by the display update device is blown toward a display surface of the electronic paper from an outside of the fake nail onto the fake nail fixed on a nail of a human body such that the display surface of the electronic paper becomes an outside.

5. A display update device for updating a display of a nonvolatile display device, which carries out a change of a display according to an electric potential difference between a display surface and a surface on a side opposite to the display surface, comprising:
an ion-wind generating portion generating a positive ion and a negative ion selectively; and
a blowing portion blowing an ion wind of an ion generated by the ion-wind generating portion toward a first surface of the nonvolatile display device where one of the display surface and the surface on the side opposite to the display surface of the nonvolatile display device is the first surface.

6. The display update device according to claim 5, wherein the nonvolatile display device is an electronic paper.

7. The display update device according to claim 5, wherein the nonvolatile display device is an electronic paper provided in a fake nail as a display member.

8. A display system comprising the display update device according to claim 5, and the nonvolatile display device.

9. A display system comprising the display update device according to claim 5, the nonvolatile display device, and an antistatic member which partially masks the first surface of the nonvolatile display device so as not to be charged by the ion wind.

10. A display update device which is the display system according to claim 8, wherein the nonvolatile display device is an electronic paper.

11. A display system which is the display system according to claim 8, wherein the nonvolatile display device is an electronic paper provided in a fake nail as the display member.
